(19) United States
(12) Patent Application Publication
(10) Pub. No.: US 2014/0103089 A1
(43) Pub. Date: Apr. 17, 2014

(54) FASTENING TOOL AND METHOD OF OPERATION

(71) Applicant: Patrick Hale, Burlington (CA)

(72) Inventor: Patrick Hale, Burlington (CA)

(21) Appl. No.: 13/650,436

(22) Filed: Oct. 12, 2012

(51) Int. Cl. B25C 1/04

(52) U.S. Cl. 227/147

(57) ABSTRACT

A fastening tool has a tool body and a driver, the driver having a percussion head drivable generally vertically downward upon receiving a blow from a hammer. The tool includes a fastener head for apply a percussion drive in a generally diagonal direction to a fastener lodged in a strike position in the fastening tool. An elongate flexible transmission element moves in a track between the percussion head and the fastener head for transforming the vertically downward hammer drive into the generally diagonal drive to drive the fastener into the edge of a floorboard. The fastening tool can be used much closer to a finishing wall than known board fastening tools.

### FIELD OF THE INVENTION

This invention relates to fastening tools and has particular application for fastening floorboards to a subfloor.

### DESCRIPTION OF RELATED ART

Floorboards for hardwood floors are generally milled as lengths of several feet and widths of a few inches. Typically the boards are from a half to one inch in thickness with one edge formed with a tongue and the other edge formed with a matching groove. The boards are laid edge to edge with the tongue of one board inserted into the groove of the next adjacent board. The boards are laid successively from one wall of the room being covered. For a neat appearance and to avoid the presence of grooves between adjacent boards where detritus can gather, a board being nailed is pressed tightly against the previously laid board before it is fastened.

Generally boards are fastened using nails or staples so that the fastener is not visible in the finished floor. One way of doing this is to drive the fastener diagonally into the side of the board so that the fastener penetrates the edge of the board at an entry position spaced from the top face of the board. The fastener is driven through a lower part of the board, exits the bottom face of the board and enters the subfloor. The fastener is driven some way into the subfloor and the frictional grip between the leading part of the nail or staple and the subfloor material such as plywood retains the fastened board in position against the subfloor and against its neighbouring board. The boards are laid in sequence so that the grooved edges face the starting wall and fasteners are driven through the tongued edges. The fastener is driven into the tongued edge at 45 degrees to the vertical at the corner junction between the top edge portion of the board and the top face of the tongue. In this way, the fastener does not protrude in such a way as might adversely affect the fitting of the next board to be fastened against the board previously fastened. The successive fastening in this way means that an essentially integral floor structure is obtained with each fastening of a board contributing through the tightly interlocking of the tongue and groove arrangement to the clamping in place of its neighbouring boards.

The angled drive applied to a fastener has two mechanical effects. Firstly, the horizontal component of the applied angled drive presses a board to be fastened laterally against the previously laid board so that the respective tongue and groove are locked and the adjacent edges of the two boards are pressed tightly together. Secondly, the vertical component of the applied angled drive presses the board being fastened firmly against the subfloor so that there is no gap between the board and the subfloor after the fastening operation is complete. The two mechanical effects overlap during the driving operation so that the lateral pressure is applied to the board as it is fixed to the subfloor.

A conventional fastening tool has a cartridge of fasteners such as staples or nails, a multiple charge of fasteners being spring mounted in the cartridge so as to bias a leading fastener into a position ready for its being driven. The tool has a rebated shoe which is used to locate the tool next to a board in the proper position for executing a fastening operation. The rebate is dimensioned so that its top face sits on top of the board to be fastened, its vertical face fits against the tongued end of that board, and an adjacent heel section of the shoe rests on the subfloor. The shoe has a launch aperture through which the readied fastener is driven in an operation as previously described. Once the fastener is driven into the board, the next adjacent fastener in the cartridge is spring biased into the ready position and the tool is lifted away from the board and located against another section of the board edge in preparation for driving another fastener.

In order that the fastener is effectively driven through the board and into the subfloor, a drive must be applied longitudinally to the fastener; i.e. along the line of the shank in the case of a nail and along the line of the two penetrating spikes in the case of the staple which is generally of the form of an inverted U. The drive applied is a percussive drive rather than the application of a high, non-percussive force. This, in turn, means that a hammer element such as a hammer head or a piston must gain momentum before it strikes the readied fastener to drive it through an edge portion of a board and into the subfloor. In a mechanical version of the flooring tool, a piston is spring mounted for reciprocation in a tool barrel. The piston has a leading edge adapted to strike the readied fastener and a strike head at the other end of the piston which is hammered to effect piston movement against the spring mounting to drive the leading edge against the fastener. In the case where such a tool uses an adjunct power source, there is usually a two-phase drive. Typically, such an adjunct power source is compressed air, although power sources, such as electromagnetism, flammable expanding gases (e.g. propane), or a small explosive charge may alternatively be used. It is understood that although compressed air is the favoured and effectively the most used fluid for fastener driving tools, other suitable compressible fluids or other power adjuncts could be used without departing from the scope of the present invention. For a compressed air powered driving tool, a top piston is first hammered against a spring bias to initiate drive of the top piston along a barrel. At a certain distance along its travel, the top piston clears an aperture in a wall of the barrel allowing fluid communication with a source of compressed air. Compressed air is then injected into the barrel to force a bottom piston against the readied fastener.

One issue with known board fastening tools is that a finite travel of the piston (or pistons in the case of the compressed air tool) in the barrel is needed to generate the required momentum for the fastener to be driven into the board and subfloor from its readied position. In addition, a swing of the hammer is required that further lengthens the drive room needed. Because swinging the hammer and driving the piston along the inclined barrel occur in the direction that the boards are being laid—i.e. away from the starting wall—this means that as illustrated by FIG. 1, the driving tool cannot be used to fasten the last few boards before the finishing wall. The number of rows is dependent on the width of the boards. Typically, for 3 inch boards, operation on the last four rows is prevented; for 4.5 inch boards, operation on the last 3 rows is prevented, etc. To finish the installation a different nail gun, known as a “brad-nailer”, is used, this tool using a smaller gauge nail; 1-2″ in comparison with a 2″ staple conventionally used by the board fastening tool. Such nailers are less effective for fastening floorboards as they do not provide the desired angular drive to a fastener.

### SUMMARY OF THE INVENTION

According to one aspect of the invention, there is provided a board fastening tool comprising a tool body and a driver, the driver having a percussion head drivable in a first direction upon receiving a first percussion drive from a hammer member, a fastener head to apply a second percussion drive in a second direction to a fastener lodged in a strike position in the fastening tool, and a transmission element between the percussion head and the fastener head for transforming the first percussion drive into the second percussion drive.

Preferably, the transmission element includes an elongate flexible member mounted in and reciprocably movable along a curved track, the elongate flexible member conformable to the curvature of the track on movement of the elongate member along the track. The elongate flexible member can be a spring steel member elastically conformable to the curvature of the track upon movement of the spring steel member along the track.

The curved track is preferably contiguous with a first passage, the fastener head mounted for reciprocal, linear movement along the first passage, with the fastener head being reciprocally movable along the first passage on an axis inclined at an angle between 30 and 60 degrees to the horizontal when the fastening tool is in an operational position.

The curved portion of the track can be contiguous with a second passage, the percussion head including an elongate driver member mounted for reciprocal, linear movement along the second passage, with the second passage extending generally vertically when the board fastening tool is in an operational position.

For use with a fastener having a contact end, the board fastening tool, the fastener head have a leading tip with a shape generally matching the shape of the fastener contact end.

The board fastening tool can further comprise an adjunct power unit operable in response to the first percussion drive to apply power for the second percussion drive. The percussion head can include a reciprocally drivable anvil for receiving the percussion drive from the hammer member, the anvil linked to a power actuator for triggering generation of a power pulse from the adjunct power unit to drive the elongate driver member along the second passage upon downward movement of the anvil. The power source can be any convenient adjunct power but is preferably compressed air.

The elongate flexible member can be constrained to move along the curved track by a track wall confining the elongate member to a preset curvature. The elongate flexible member can include a plurality of elements, adjacent elements linked to each other along the length of the flexible member by a respective articulated linkage. Alternatively, elongate flexible member is a longitudinally incompressible cable.

The transmission element can include a rotatable member rotatable about an axis, the rotatable member having a first contact element drivable by the percussion head on movement of the percussion head in the first direction to turn the rotatable member about the axis, and a second contact element forming a part of the rotatable member for driving the fastener head in the second direction upon turning of the rotatable member about the axis.

According to another aspect of the invention, there is provided a method of fastening a floor board using a fastening tool having a tool body and a driver, the driver having a percussion head and a fastener head and a transmission element linking the percussion head and the fastener head, the method comprising applying a first percussion drive to the percussion head to drive the percussion head in a first direction, transforming the first percussion drive into a second percussion drive at the transmission train, applying the second percussion drive to the fastener head to drive the fastener head in a second direction to strike a fastener lodged in a strike position in the fastening tool.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a side view of a floorboard driving tool known in the prior art.

FIG. 2 is a side view of a floorboard driving tool embodying the invention.

FIGS. 3 to 5 are vertical section views through a body section of the tool of FIG. 2 showing stages in the use of an adjunct power source to drive fasteners according to an embodiment of the invention.

FIG. 6 is a perspective view showing a shoe forming part of a floorboard fastening tool, the shoe shown in juxtaposition to floorboards being fastened to a subfloor.

FIG. 7 is a vertical sectional view through a lower section of the tool of FIG. 2 showing the tool in a strike (or “fastener ready”) condition.

FIG. 8 is a vertical sectional view corresponding to the view of FIG. 7, but showing the tool following completion of a fastening operation.

FIG. 9 shows a front elevation of a driver for use in a tool according to an embodiment of the invention.

FIG. 10 is a vertical sectional view of the driver of FIG. 9.

FIG. 11 shows the driver of FIG. 9 in side elevation showing the driver in deployed condition.

FIG. 12 is a front elevation of an alternative design of driver according to an embodiment of the invention.

FIG. 13 is a side elevation of the driver of FIG. 12.

FIG. 14 is a front elevation of an alternative design of driver according to an embodiment of the invention.

FIG. 15 is a side elevation of the driver of FIG. 14.

FIG. 16 is a sectional view through a flexible section of the driver of FIG. 14.

FIG. 17 is an end view of the driver of FIG. 14 at the fastener driving end.

### DETAILED DESCRIPTION OF THE INVENTION INCLUDING THE PRESENTLY PREFERRED EMBODIMENTS

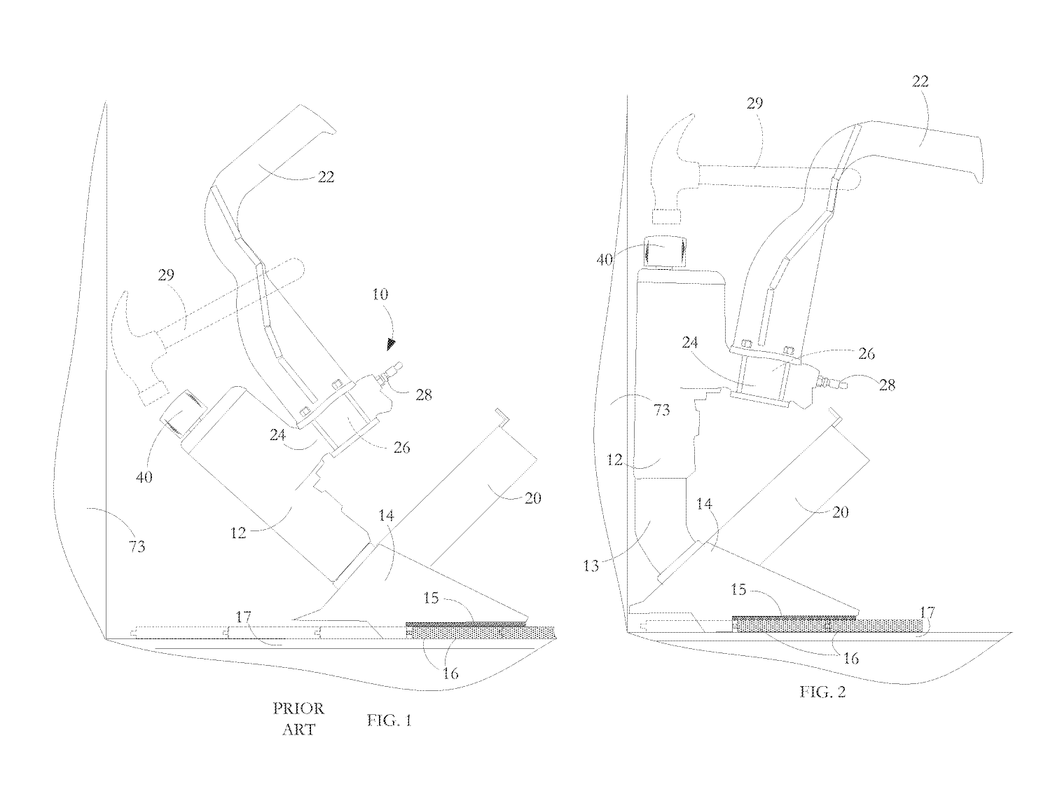

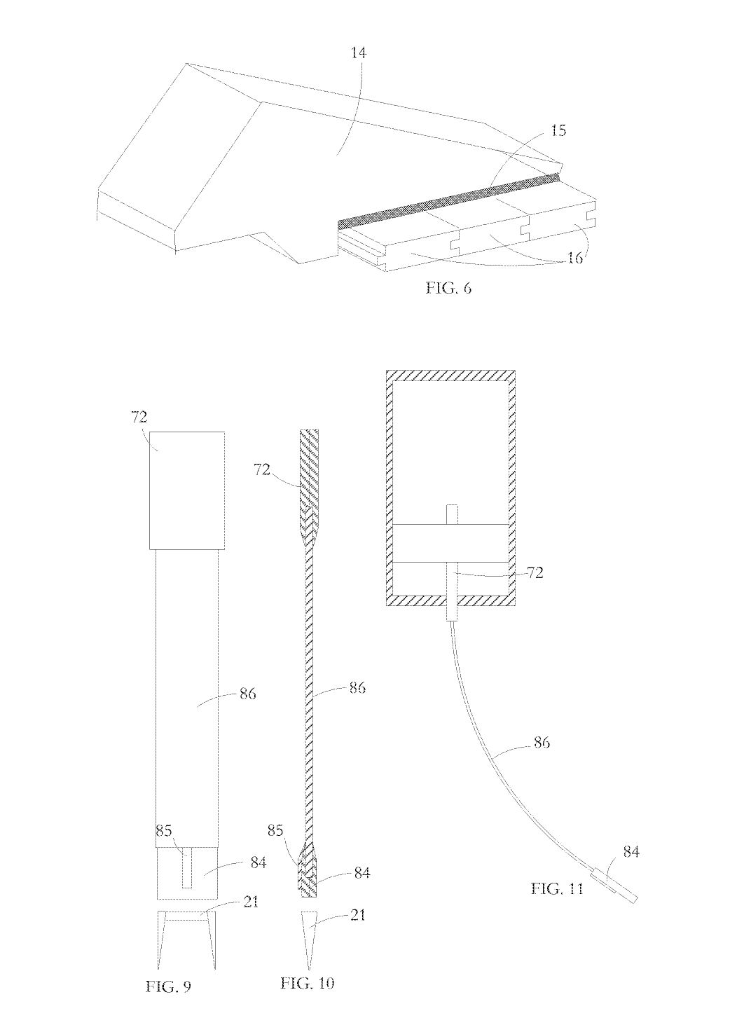

FIGS. 1 and 2 shows pneumatic fastener driving tools 10, each having a hollow generally barrel-form body 12. A shoe 14 for engaging a tongue and grooved floorboard 16 to be fastened to a sub-floor 17 is mounted at a lower end of the body 12. The shoe 14 includes a passage for receiving a leading fastener from a spring-loaded series of fasteners fed from a magazine 20. The fasteners are conventionally either nails or staples. In use, the passage guides the lead fastener from a strike position into the tongued end of a floorboard 16 to be fastened with the floorboard located under the shoe 14 as shown in FIG. 6 as the lead fastener is driven out of the driving tool 10. Because any of a range of thicknesses of board may be used, a spacer 15 is attached to an underside rebated part of the shoe 14 so as to adapt the rebate height to the thickness of boards 16 to be fastened to the subfloor 17. The fastener driving tool 10 has a handle 22 mounted to a spur member 24 projecting from the body and integral with it. The spur member 24 has an inner chamber 26 for containing a charge of compressed air, the member having a connector 28 in its wall for connection to a source of compressed air. Driving of a fastener into the edge of a board and into the subfloor is initiated by swinging a hammer 29 and striking a cap covered anvil 40. The tool of FIG. 1 is known prior art. The tool of FIG. 2 tool has a coupling section 13 linking the barrel body 12 and an upper part of the shoe 14 and embodies principles of the present invention.

Shown in sectional view in FIGS. 3 to 5 is an arrangement of elements for the tool of FIG. 2, the elements functioning to provide a compressed air power source for converting a blow from the hammer 29 applied to the anvil 40 to an impulsive or percussive force of desired power and speed at a readied fastener. The body 12 has lower and upper chambers, respectively, 30 and 32. An annular seat 34 integrally formed with the body inner wall separates the chambers 30 and 32. An opening 36 permits continuous air exchange between the chambers 26 and 32. The body 12 is fitted at its upper end with a cover 38 from which protrudes a slidable anvil member 40 through a top opening 42, the anvil member 40 being covered with a soft cap 44. Anvil member 40 is attached at its lower end to an annular actuator 46 which seals against the interior of chamber 32 and is axially slidable along it. The actuator 46 sealingly engages the outer surface of a hollow cylindrical poppet valve 48 which has an inner channel 50. A lower end of the poppet valve 48 is formed with a conical valve head 52 which is operable to engage with and disengage from a face of the complementarily shaped annular seat 34. Poppet valve member 48 has several radial bores 56 located near valve head 52. A hollow piston 58 is axially slidable inside the channel 50, the piston 58 being guided by means of a sleeve 60 which slidably and sealingly engages the inner wall of poppet valve member 48 at an upper end of the piston. The piston 58 is guided at its lower end by a disc 62 attached to the piston 58 which slidingly and sealingly engages the main body 12 inner wall, the disc 62 having a dish form upper surface 63. A bore 64 extends longitudinally through the centre of the piston 58, the bore providing fluid communication via vent passages 66 between a portion of the upper chamber 32 located above actuator 46 and the portion of lower chamber 30 located above slider disc 62. Exhaust holes 68 are located between the lower end of anvil 40 and the upper end of actuator 46, the holes being in registration with corresponding exhaust holes 70 in cover 38.

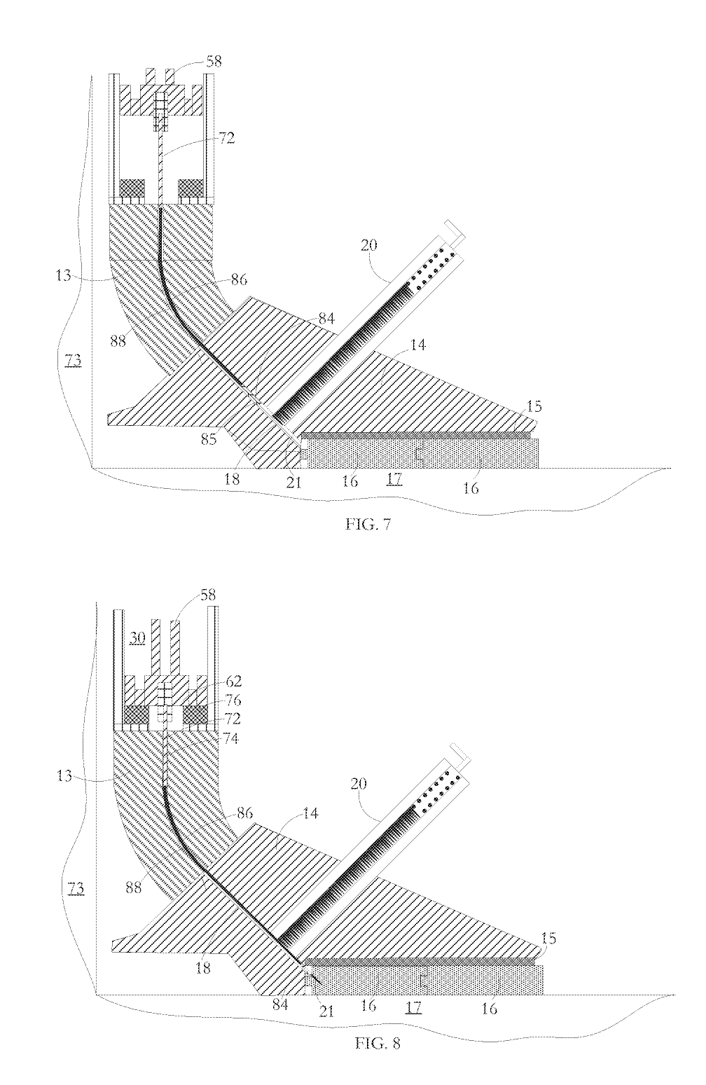

A driver member 72 is attached to the lower end of piston 58 and is vertically drivable into and out of a straight vertical track section 74 in shoe 14 (FIGS. 7 and 8). A pad 76 is located at the bottom end portion of lower chamber 30, to receive and absorb the impact of the downwardly propelled disc 62. The lower and upper chambers 30, 32 are lined to enable smooth sliding engagement of disc 62 in lower chamber 30 and of actuator 46 in upper chamber 32. The anvil 40 encloses a chamber 82 which acts as a shock absorber to dampen upward movement of piston 58 when the piston is biased upwardly after a fastener has been driven by the action of the compressed air on the sleeve 60. Once the upper ends of sleeve 60 and piston 58 move into chamber 82, the air trapped in the chamber acts as a dampening cushion to reduce the impact during use of the piston slider disc 62 against lower seat 34.

Referring to FIGS. 7 and 8, a driver has three contiguous elements: a generally vertically disposed driver member 72, a blade tip 84, and a flexible spring steel member 86 extending between the driver member 72 and the blade tip 84. The driver member 72 is mounted centrally of the piston 58 and has a lower part received in a vertical track section 74 formed in the coupling section 13. The drive member 72 is driven vertically up and down with the movement of the piston 58 previously described with reference to FIGS. 3 to 5. The blade tip 84 is mounted for reciprocal linear movement within the inclined passage 18 in the shoe 14. A lead fastener 21 from the fasteners stored in the magazine 20 is automatically biased to a ready or strike position in the passage 18 as shown in FIG. 7. The spring steel member 86 is reciprocally moveable within a curved track 88 in the coupling section 13, the curved track contiguous with the track sections 18 and 74. The spring steel member 86 transforms the vertical reciprocation of the driver member 72 into reciprocation of the blade tip 84 within the angled passage 18. The driver member 72 and the blade tip 84 are made of hardened steel and the member 86 is made of spring steel. Examples of suitable spring steel are as follows, the chrome-silicon spring steel being especially valuable for its fatigue resistance.

| | SAE | | Yield | |
|---|---|---|---|---|
| Material | grade | Composition | strength | Hardness |
| Blue spring | 1095 | 0.9-1.03% carbon, | 413-517 | Up to 59 |
| steel | | 0.3-0.5% manganese, | megapascals | HRC |
| | | up to 0.04% phosphorus, | | |
| | | and up to 0.05% | | |
| | | silicon | | |
| Chrome- | 5160 | 0.55-0.65% carbon, | 669 | Up to 63 |
| silicon | | 0.75-1.00% manganese, | megapascals | HRC |
| spring steel | | 0.7-0.9% Chromium | | |

The spring steel member 86 is of the order of 0.25 inches in thickness and a half inch in width. It is welded at one end to the rigid driver member 72 and at the other to the blade tip 84 by a tungsten inert gas welding process. As shown in the embodiment of FIGS. 9 to 11, at both ends, the spring steel member 86 is welded between two flanking plates having accommodating rebates. The spring steel member can alternatively be welded at a rebate in one face of the member and blade tip or can be welded as a pair of spring steel members to opposed surfaces of the driver member and the blade tip. In the fastener ready position as shown in FIG. 7, the spring steel member 86 is positioned so that an upper part is in the top straight track section 74 and a lower part is in the curved track 88. In a fastener driven position as shown in FIG. 8, an upper part of the spring steel member 86 is in the curved track 88 and a lower part of the spring steel member 86 is in the straight track section 18.

In use, the fastener driving tool 10 is in a resting position as shown in FIG. 3. In this position, within the barrel 12 of the tool, atmospheric pressure exists in the annular area above the actuator 46 and exists also both in the area of lower chamber 30 between the poppet valve head 74 and the disc 62 and in the lower chamber 30 under slider disc 62. Compressed air is continuously fed into reservoir 26 through connector 28 and so chamber 32, which is in in continuous communication with air reservoir 26, is also filled with compressed air. Because the lower face of the actuator 46 has a greater surface area than the upper conical face of valve member head 52, the overall pressure differential on the poppet valve 48 upwardly biases the poppet valve member 70 to an upper limit position to sealingly engaging the valve head against seat 34. Compressed air is also allowed through bores 56 into poppet channel 50 under sleeve 60, to upwardly bias the sleeve 90 and its associated piston 58 to an upper limit position.

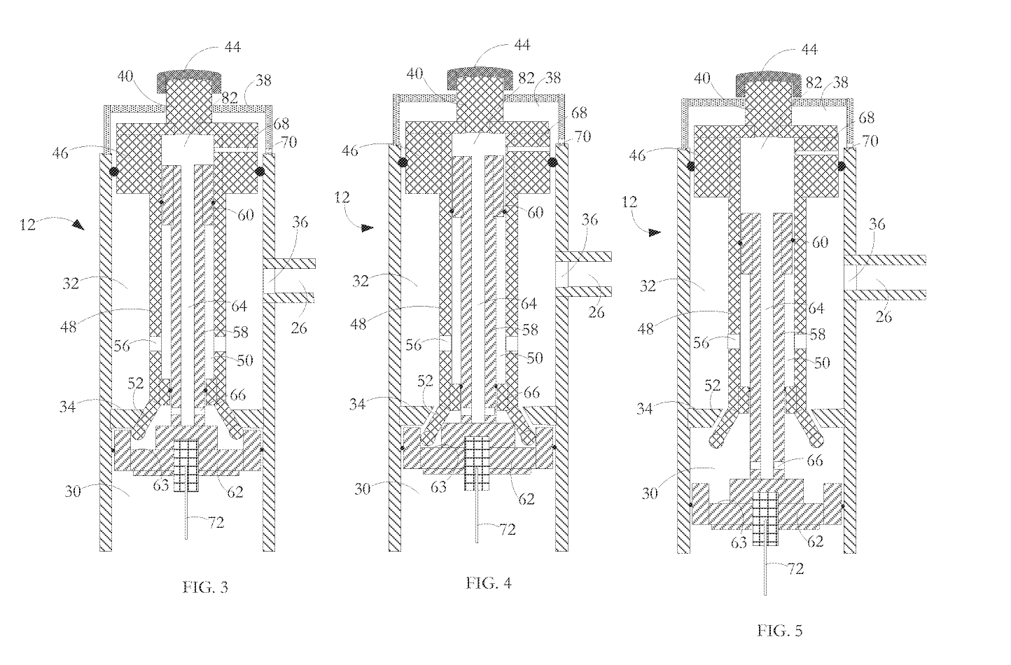

When a hammer blow is applied to anvil 40, actuator 48 is driven downwardly in chamber 32 as shown in FIG. 4. Provided the hammer blow has a force sufficient to counteract the pressure differential resulting from the surface area differential between the actuator 46 and the valve member 52, the actuator 46 and poppet member 48 engaged by it are moved downwardly as shown in FIG. 4. Once the valve member 52 is at a lowered position, compressed air can flow around it into lower chamber 30 above disc 62. Since atmospheric pressure exists under disc 62, the latter is suddenly downwardly driven by the incoming compressed air to downwardly drive the drive member 72 as shown in FIG. 5. Since the surface area of upwardly facing disc 62 is greater than the surface area of downwardly facing sleeve 60, the resistance exerted by the sleeve 60 to the downward movement of piston 58 is insignificant. Once piston 58 hits annular pad 76, it reaches its lowermost position.

As shown by FIGS. 7 and 8, the downward movement of member 72 is transmitted to the spring steel member 86 and the blade tip 84. The spring steel member 86 is forced into a curved configuration as it slides against a back wall of the curved track 88. Both the spring steel member and the back wall are burnished to minimize friction between them. Sliding of the spring steel member 86 in the curved track 88 is also facilitated by the application of lubricant. The spring steel member 86 is prevented from moving laterally by the mounting of the drive member 72 in the piston 58 at the upper end of the spring steel member and by the reciprocation of the piston 58 in the barrel body 12. The passage 18 has a groove in its back wall which receives a projecting rib 85 on the blade tip 84 as illustrated in FIGS. 9 to 11. This ensures good tracking of the blade tip 84 in the passage 18. As shown in FIGS. 9 and 10, the blade tip 84 is matched to the head shape of the fastener 21. I.e., it is a blade edge for use in driving a staple and is a circular punch-like tip for driving a nail.

It can be seen that the vertical reciprocation of the member 72 results in the blade tip driving a staple fastener 21 diagonally into the floorboard 16 as shown in FIG. 8. Moreover, compared with the prior art as illustrated in FIG. 1, it will be apparent that the driving tool 10 can be used to fasten boards 16 that are closer to the “finishing” wall 73 than is possible with the design shown in FIG. 1.

The blow to anvil 40 only temporarily shifts the pressure balance in the tool main body 12. The pressure balance quickly returns to its initial condition after the hammer blow has been effected and the lead fastener has been driven into a floorboard 16. At this point, poppet valve 48 returns to its resting position owing to the greater pressure applied by the compressed air on the bottom of the actuator 46 than on the top of the poppet valve 48. The poppet valve member 48 sealingly engages the seat 34 once again under the bias of the upwardly moving actuator 46. The compressed air in the chamber 30 above disc 62 flows through holes 66 into piston channel 64, through poppet channel 50 (above sleeve 60) and out of tool 10 through exhaust holes 68 and 70. Once the pressure in lower chamber 30 above disc 62 nears atmospheric pressure, the upward pressure applied by the compressed air against sleeve 60 drive piston 58 upwardly in poppet channel 50 back to its initial upper limit position as shown in FIG. 3. The upward movement of piston 58 is dampened when it nears its upper limit position, by the presence of an air cushion at atmospheric pressure in dampening chamber 82.

The fastening tool has some tendency to lift slightly from the flooring when a fastener is expelled due to the outcoming fastener hitting the hard floor, which may result in the fastener not being properly driven into the board and subfloor. Because the hammer blow applied to the anvil 40 is downwardly directed, this helps to prevent the tool from this slight upward reaction.

The function of the spring steel member 86 housed within the curved track is to convert the downward motion of the anvil to the diagonal motion of the blade tip. Although the spring steel member (or members) 86 is preferred, the transformation in drive direction can be effected with alternative mechanical devices. In one alternative, as shown in FIGS. 12 and 13, the driver flexible central section is implemented by means of linked sections in the manner of a watch band or bicycle chain but configured to adapt the articulated chain to movement within the contiguous passages 74, 88, 18 and configured also to withstand repeated pulsed application of pressure along the longitudinal extent of the chained linkages as the tool is operated to drive in fasteners. In this respect, it will be understood that both in this and the driver embodiments described below, while the blade tip 84 must be matched to the head of the fastener, the implementation of the flexible driver upstream of the blade tip can be as required in order to have the driver withstand the impulse application of pressure at the drive member 72 and the repeated flexures of the central driver section 86.

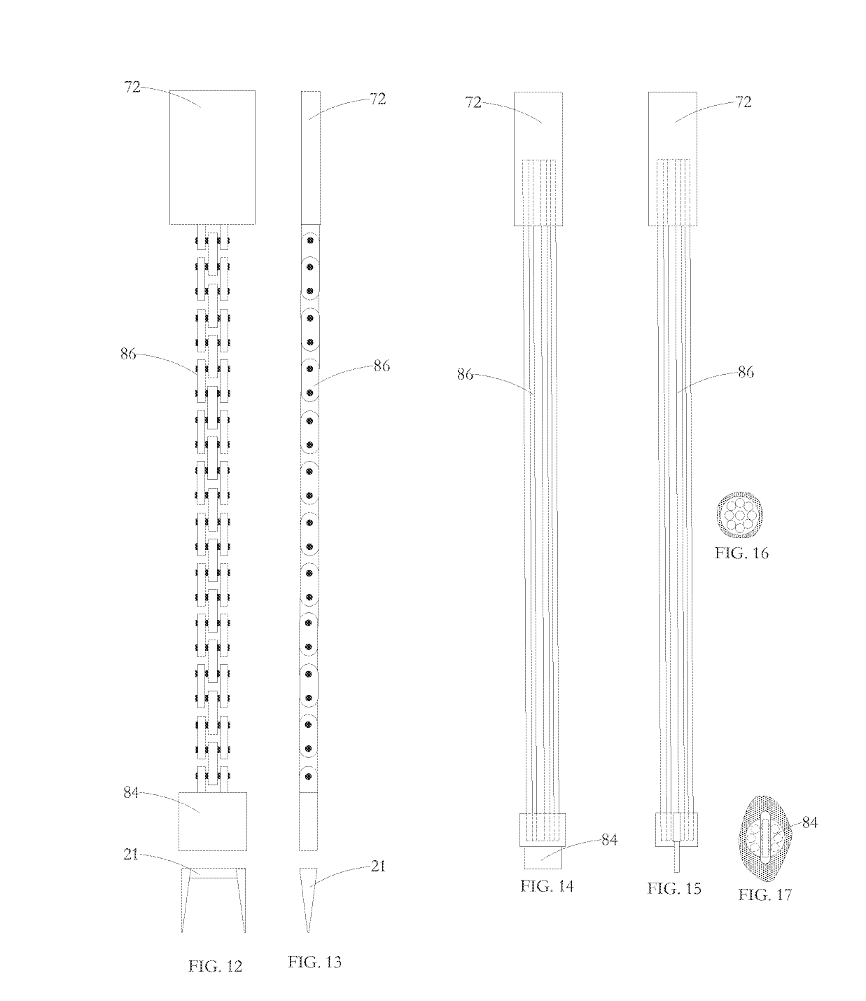

In a further embodiment as shown in FIGS. 14 and 15, the flexible section 86 of the driver is implemented by means of a cable such as aircraft cable which is housed within and moves along a curved track having a cross sectional shape and area to accommodate the cable diameter and to permit the cable to slide relatively freely backwards and forwards along the curved track.

In yet another embodiment, the transformation from vertical hammer direction to diagonal drive bit direction might be achieved using a rotary member having a first lug positioned in the path of the driver member in the fastener ready position to enable the rotary member to be turned as the first lug is truck by the downwardly moving driver member. The rotary member can have a second lug position so that as the rotary member rotates, the second lug collides with the drive bit to drive the drive bit against a readied fastener.

It will be appreciated that in each of the foregoing embodiments, the blade tip is driven by the spring steel driver to eject the readied fastener out of the fastening tool and into the floorboard to be fastened generally at the corner between the bottom edge of the board and the upwardly orientated face of the tongue. The force applied to the fastener is diagonally directed and so one component of this acts to drive the board being fastened against the previously laid board to squeeze the two boards together at the moment of impact.

While the specific embodiments described above relate to a board fastening tool for fastening a floor board to an underlying structure such as a subfloor, it will be appreciated that the principles of the invention can be used on other fastening tools such as trim guns and framing guns where space in relation to a “finishing” wall or other limiting surface or object means that the actuating room for the tool is limited. Tools of a range of sizes, both manually operated and power assisted can use the principles of the invention.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A fastening tool having a tool body and a driver, the driver having a percussion head drivable in a first direction upon receiving a first percussion drive from a hammer member, a fastener head to apply a second percussion drive in a second direction to a fastener lodged in a strike position in the fastening tool, and a transmission element between the percussion head and the fastener head for transforming the first percussion drive into the second percussion drive.

2. A fastening tool as claimed in claim 1, the transmission element including an elongate flexible member mounted in and reciprocably movable along a curved track, the elongate flexible member conformable to the curvature of the track on movement of the elongate member along the track.

3. A fastening tool as claimed in claim 2, the elongate flexible member being a spring steel member elastically conformable to the curvature of the track upon movement of the spring steel member along the track.

4. A fastening tool as claimed in claim 2, the curved track contiguous with a first passage, the fastener head mounted for reciprocal, linear movement along the first passage.

5. A fastening tool as claimed in claim 4, the fastener head reciprocally movable along the first passage on an axis inclined at an angle between 30 and 60 degrees to the horizontal when the fastening tool is in an operational position.

6. A fastening tool as claimed in claim 4, the curved portion of the track contiguous with a second passage, the percussion head including an elongate driver member mounted for reciprocal, linear movement along the second passage.

7. A fastening tool as claimed in claim 6, the second passage extending generally vertically when the board fastening tool is in an operational position.

8. A fastening tool as claimed in claim 1, the board fastening tool for use with a fastener having a contact end, the fastener head having a leading tip with a shape generally matching the shape of the fastener contact end.

9. A fastening tool as claimed in claim 1, the percussion head including a reciprocally drivable anvil for receiving the percussion drive from the hammer member, the anvil linked to a power actuator for triggering generation of a power pulse from a power source to drive the elongate driver member along the second passage upon downward movement of the anvil.

10. A fastening tool as claimed in claim 9, the power source being a source of compressed air.

11. A fastening tool as claimed in claim 2, the elongate flexible member constrained to move along the curved track by a track wall confining the elongate member to a preset curvature.

12. A fastening tool as claimed in claim 2, the elongate flexible member including a plurality of elements, adjacent elements linked to each other by a respective articulated linkage.

13. A fastening tool as claimed in claim 1, the elongate flexible member being a longitudinally incompressible cable.

14. A fastening tool as claimed in claim 1, the transmission element including a rotatable member rotatable about an axis, the rotatable member having a first contact element drivable by the percussion head on movement of the percussion head in the first direction to turn the rotatable member about the axis, and a second contact element forming a part of the rotatable member for driving the fastener head in the second direction upon turning of the rotatable member about the axis.

15. A fastening tool as claimed in claim 1, further comprising an adjunct power unit operable in response to the first percussion drive to apply power for the second percussion drive.

16. A fastening tool as claimed in claim 1, the fastening tool being a board fastening tool, the fastener being one of a nail and a staple.

17. A method of fastening a using a fastening tool having a tool body and a driver, the driver having a percussion head and a fastener head and a transmission element linking the percussion head and the fastener head, the method comprising applying a first percussion drive to the percussion head to drive the percussion head in a first direction, transforming the first percussion drive into a second percussion drive at the transmission train, applying the second percussion drive to the fastener head to drive the fastener head in a second direction to strike a fastener lodged in a strike position in the fastening tool.
